(19) United States
(12) Patent Application Publication
(10) Pub. No.: US 2014/0271758 A1
(43) Pub. Date: Sep. 18, 2014

(54) OVERCOATED POWDER PARTICLES

(71) Applicants: Syngenta Crop Protection LLC, Greensboro, NC (US); AGROFRESH INC., Spring House, PA (US)

(72) Inventors: Yueqian Zhen, Paoli, PA (US); Niall Rae Thomson, Wokingham (GB)

(73) Assignees: Syngenta Crop Protection LLC, Greensboro, NC (US); AGROFRESH INC., Spring House, PA (US)

(21) Appl. No.: 14/203,886

(22) Filed: Mar. 11, 2014

Related U.S. Application Data
(60) Provisional application No. 61/781,636, filed on Mar. 14, 2013.

(51) Int. Cl. A01N 25/28; A01N 27/00

(52) U.S. Cl. CPC A01N 25/28; A01N 27/00
USPC 424/408; 514/763

(57) ABSTRACT

Provided are compositions comprising a collection of overcoated particles wherein each of the overcoated particles comprises a first coating and a second coating. In one embodiment, the first coating comprises water-insoluble material, for example a fatty compound or a waxy material. In another embodiment, the second coating comprises a water-insoluble polymer or water-resistant film, wherein the water-insoluble polymer of the second coating is different than the water-insoluble material of the first coating. Also provided is a slurry comprising water and overcoated powders provided herein. Also provided is a method of contacting plants or plant parts with a composition or slurry provided herein.

### CROSS-REFERENCE TO RELATED APPLICATION

This application claims the benefit of U.S. Provisional Patent Application Ser. No. 61/781,636, filed Mar. 14, 2013, the disclosure of which is hereby incorporated herein in its entirety by this reference.

### BACKGROUND OF THE INVENTION

One desirable way of treating plants or plant parts is to prepare a liquid composition that contains one or more cyclopropene compound and then apply that liquid composition to plants or plant parts. It is contemplated that such treatment is useful for blocking the effects of ethylene in the treated plants or plant parts. One useful way of preparing such a liquid composition is to make an encapsulation complex in which a molecule of a cyclopropene compound is encapsulated in a molecule of a molecular encapsulating agent. The encapsulation complex can be made into a powder, which can be conveniently stored and transported. One method of using such a powder is to make a liquid composition by mixing the powder with water, possibly along with other ingredients, and bringing the resulting liquid composition into contact with plants or plant parts, for example by spraying or dipping.

One difficulty that arises with such a method of making and using such liquid compositions is that contact with water may cause the cyclopropene compound to release from the encapsulation complex too quickly. Release of cyclopropene compound that happens too quickly can cause several problems. If the liquid composition is in an enclosed container such as inside a spray tank, undesirably high levels of cyclopropene compound may accumulate in the headspace of the container. Also, if the liquid composition is sprayed or is placed into an open tank (e.g., an open tank into which plants or plant parts will be dipped), undesirable amounts of cyclopropene compound may be released to the atmosphere and become unavailable for coming into contact with plants or plant parts.

U.S. Pat. No. 5,384,186 describes perfume/cyclodextrin complexes suspended in polyalkylene glycol carrier material.

It is desired to provide a powder composition that contains one or more cyclopropene compound and that, when mixed with water, retards the release of cyclopropene compound but does not entirely prevent the release of cyclopropene compound.

### SUMMARY OF THE INVENTION

Provided are compositions comprising a collection of overcoated particles wherein each of the overcoated particles comprises a first coating and a second coating. In one embodiment, the first coating comprises water-insoluble material, for example a fatty compound or a waxy material. In another embodiment, the second coating comprises a water-insoluble polymer or water-resistant film, wherein the water-insoluble polymer of the second coating is different than the water-insoluble material of the first coating. Also provided is a slurry comprising water and overcoated powders provided herein. Also provided is a method of contacting plants or plant parts with a composition or slurry provided herein.

In one aspect, provided is a composition comprising a collection of powder particles, wherein each of the powder particles comprises,
(a) one or more inner particles comprising a complex powder, the complex powder comprises a cyclopropene compound encapsulated by a molecular encapsulating agent;
(b) a first coating comprising a water-insoluble material; and
(c) a second coating comprising a water-insoluble polymer or a water-resistant film.

In one aspect, provided is a composition comprising a collection of powder particles, wherein each of the powder particles comprises,
(a) one or more inner particles comprising a complex powder, the complex powder comprises a cyclopropene compound encapsulated by a molecular encapsulating agent; each of the one or more inner particles comprises a first coating comprising a water-insoluble material; and
(b) a second coating comprising a water-insoluble polymer or a water-resistant film.

In one embodiment of the compositions provided, the water-insoluble material of the first coating comprises a fatty compound or a waxy material. In another embodiment, the water-insoluble polymer of the second coating is different than the water-insoluble material of the first coating.

In another embodiment, the powder particles have median particle diameter of 10 micrometers to 500 micrometers. In another embodiment, the powder particles have median particle diameter of 20 micrometers to 250 micrometers. In another embodiment, the fatty compound or waxy material of the first coating has a melting point of 50° C. to 110° C. In another embodiment, the fatty compound or waxy material of the first coating has a melting point of 70° C. to 90° C.

In one embodiment, the fatty compound or waxy material of the first coating comprises at least one of hydrogenated soybean oil, hydrogenated cottonseed oil, hydrogenated sunflower oil, microcrystalline wax, polyethylene homopolymer wax, and natural waxes including Beeswax and Carnauba wax. In another embodiment, the water-insoluble polymer or water-resistant film of the second coating comprises acrylic polymers, alkylated celluloses, polyterpenes, or combinations thereof. In another embodiment, the water-insoluble polymer or water-resistant film of the second coating comprises ethylcellulose polymers. In a further or alternative embodiment, the ethylcellulose polymers comprise Ethocel.

In one embodiment, the composition is prepared using spray drying or spinning disk from prills dispersed in a hydrophobic solvent. In a further embodiment, the hydrophobic solvent is hexane. In another embodiment, the composition comprises polyterpene resin Piccolyte A135, S115, or S125 (for example, Piccolyte A135 from Pinova Inc.). In a further embodiment, the polyterpene resin Piccolyte A135, S115, or S125 is by weight from 10% to 50%. In a further embodiment, the polyterpene resin Piccolyte A135, S115, or S125 is by weight from 25% to 50%. In another embodiment, the composition is prepared from fluid bed coating. In a further embodiment, the fluid bed coating comprises an aqueous dispersion of a hydrophobic polymer, such as a styrene-acrylic copolymer one example of which is Neocryl XK-82 at 40% wt by spraying. In a further embodiment, the Neocryl XK-82 is by weight from 5-50%, 10-30%, 15-25% wt of the final coated particles. In another embodiment, the fluid bed coating comprises an aqueous solution of Neocryl XK-82 at 40% wt by spraying. In a further embodiment, the Neocryl XK-82 is by weight from 20% to 30% wt of the coated particles. In another embodiment, the fluid bed coating comprises an aqueous dispersion of an acrylic copolymer. In a further embodiment, the acrylic copolymer is by weight from 20% to 30% of the final composition. In another embodiment, the styrene-acrylic (for example styrene butyl methacrylate copolymner) is by weight from 20% to 30% of the final composition.

In another aspect, provided is a slurry comprising an aqueous medium and a collection of particles, wherein each of the powder particles comprises,
(a) one or more inner particles comprising a complex powder, the complex powder comprises a cyclopropene compound encapsulated by a molecular encapsulating agent;
(b) a first coating comprising a water-insoluble material; and
(c) a second coating comprising a water-insoluble polymer or a water-resistant film.

In another aspect, provided is a slurry comprising an aqueous medium and a collection of particles, wherein each of the powder particles comprises,
(a) one or more inner particles comprising a complex powder, the complex powder comprises a cyclopropene compound encapsulated by a molecular encapsulating agent; each of the one or more inner particles comprises a first coating comprising a water-insoluble material; and
(b) a second coating comprising a water-insoluble polymer or a water-resistant film.

In one embodiment of the slurries provided, the water-insoluble material of the first coating comprises a fatty compound or a waxy material. In another embodiment, the water-insoluble polymer of the second coating is different than the water-insoluble material of the first coating.

In another embodiment, the powder particles have median particle diameter of 10 micrometers to 500 micrometers at Dv95 as measured by a light diffraction method. In another embodiment, the powder particles have median particle diameter of 20 micrometers to 250 micrometers at Dv95. In another embodiment, the fatty compound or waxy material of the first coating has a melting point of 50° C. to 110° C. In another embodiment, the fatty compound or waxy material of the first coating has a melting point of 70° C. to 90° C.

In one embodiment, the fatty compound or waxy material of the first coating comprises at least one of hydrogenated soybean oil, hydrogenated cottonseed oil, hydrogenated sunflower oil, microcrystalline wax, polyethylene homopolymer wax, and natural waxes including Beeswax and Carnauba wax. In another embodiment, the water-insoluble polymer or water-resistant film of the second coating comprises acrylic polymers, alkylated celluloses, polyterpenes, or combinations thereof. In another embodiment, the water-insoluble polymer or water-resistant film of the second coating comprises ethylcellulose polymers. In a further or alternative embodiment, the ethylcellulose polymers comprise Ethocel.

In another aspect, provided is a method of treating plants or plant parts comprising contacting said plants or plant parts with a slurry comprising an aqueous medium and a collection of particles, wherein each of the powder particles comprises,
(a) one or more inner particles comprising a complex powder, the complex powder comprises a cyclopropene compound encapsulated by a molecular encapsulating agent;
(b) a first coating comprising a water-insoluble material; and
(c) a second coating comprising a water-insoluble polymer or a water-resistant film.

In another aspect, provided is a method of treating plants or plant parts comprising contacting said plants or plant parts with a slurry comprising an aqueous medium and a collection of particles, wherein each of the powder particles comprises,
(a) one or more inner particles comprising a complex powder, the complex powder comprises a cyclopropene compound encapsulated by a molecular encapsulating agent; each of the one or more inner particles comprises a first coating comprising a water-insoluble material; and
(b) a second coating comprising a water-insoluble polymer or a water-resistant film.

In one embodiment of the methods provided, the water-insoluble material of the first coating comprises a fatty compound or a waxy material. In another embodiment, the water-insoluble polymer of the second coating is different than the water-insoluble material of the first coating.

In another embodiment, the powder particles have median particle diameter of 10 micrometers to 500 micrometers. In another embodiment, the powder particles have median particle diameter of 20 micrometers to 250 micrometers. In another embodiment, the fatty compound or waxy material has a melting point of 50° C. to 110° C. In another embodiment, the fatty compound or waxy material has a melting point of 70° C. to 90° C.

In one embodiment, the fatty compound or waxy material of the first coating comprises at least one of hydrogenated soybean oil, hydrogenated cottonseed oil, hydrogenated sunflower oil, microcrystalline wax, polyethylene homopolymer wax, and natural waxes including Beeswax and Carnauba wax, or their synthetic equivalences. In another embodiment, the water-insoluble polymer or water-resistant film of the second coating comprises acrylic polymers, alkylated celluloses, polyterpenes, or combinations thereof. In another embodiment, the water-insoluble polymer or water-resistant film of the second coating comprises ethylcellulose polymers. In a further or alternative embodiment, the ethylcellulose polymers comprise Ethocel.

### BRIEF DESCRIPTION OF THE DRAWINGS

FIG. 1 shows exemplary release rates of 1-methylcyclopropene (1-MCP) in a water solution for three different samples. The reduction of the technical from 30% to 15% in the particles reduced the release rate dramatically. Overcoating of the same 30% technical particles to 15% technical reduced the 1-MCP release rate further.

FIG. 2 shows a comparison of overcoated particles (or coated prill) and coated particles (or prill) MO8476-9 prills (#1 & 2/3). Representative release rates under stress testing 2.0 (ST2.0) of the first group (initial coating—brushdown samples) are shown with 25% overcoating polymer. Initial sample shows dramatic reduction in release rate (i.e., increased protection).

FIG. 3 shows a comparison of spray coated samples (#5-8). Representative results of stress testing 2.0 (ST2.0) of the second group are shown. Good protection can be achieved. Sample #7 (bag house) provides adequate protection.

FIG. 4 shows exemplary relationship for coating impact between release % and polymer Piccolyte A135%. Representative release rates under stress testing 2.0 (ST2.0) versus coating % are shown. The data suggests that the more the coating polymer, the better the protection for 1-MCP release.

FIG. 5 shows an exemplary result using 20% Neocryl XK82 to overcoat particles (i.e., to produce two coatings on the particles) containing 30% w/w HAIP (i.e., 1-methylcyclopropene-Cyclodextrin complex) in Dritex S. Clear protection with 20% polymer coating can be observed.

FIG. 6 shows an exemplary result using various amounts of Neocryl XK-82 to overcoat particles (i.e., to produce two coatings on the particles) containing 40% w/w HAIP (i.e., 1-methylcyclopropene-Cyclodextrin complex) in Dritex S. Clear protection with 20% and 28% polymer coating can be observed.

FIG. 7 shows an exemplary result for effect of XK-82 SBD coating on polywax.

FIG. 8 shows an exemplary result for effect of ethyl cellulose overcoating on the release rate of 1-MCP in the 50 gallon test. Coating deposited from solution sprayed in a Wurster type process.

FIG. 9 shows representative overcoated particles provided herein.

### DETAILED DESCRIPTION OF THE INVENTION

As used herein, a “fatty group” is a chemical group that contains at least one chain of carbon atoms that is at least 8 carbon atoms long. A “fatty compound” is any compound that contains a fatty group.

Fatty acids having 24 or fewer carbon atoms are not considered herein to be polymers. Triglycerides of such fatty acids are also not considered herein to be polymers. Also not considered herein to be polymers are the following: derivatives of such fatty acids and such triglycerides, where the derivative process is hydrogenation, methylation, or other derivative process, as long as that other derivative process does not involve a polymerization reaction or a reaction of a polymer with the fatty acid or the triglyceride.

As used herein, the phrase “Polymer” refers to a relatively large molecule made up of the reaction products of smaller chemical repeat units. The repeat units (also called “monomer units”) are residues of monomer molecules. The repeat units may be all identical or may include two or more different repeat units. Polymer molecules may have any structure including, for example, linear, branched, star-shaped, crosslinked, and mixtures thereof. Polymer molecular weights can be measured by standard methods such as, for example, size exclusion chromatography (SEC, also called gel permeation chromatography or GPC). Polymers have number-average molecular weight (Mn) of greater than 700. “Oligomer” as used herein is also a molecule made up of the reaction products of smaller chemical repeat units called monomer units. Oligomers have molecular weight of 700 or less.

Thermoset polymers can be fully crosslinked. Thermoset polymers cannot be molded into new shapes by the application of heat and pressure, and thermoset polymers cannot be dissolved in any solvent. Polymers that are not thermoset are called thermoplastic polymers.

As used herein, a material is water-insoluble if the amount of that material that can be dissolved in water at 25° C. is 1 gram of material or less per 100 grams of water.

As used herein, the “softening point” of a material is the softening point as measured by ASTM Standard No. E28-99 (2009), published by ASTM International, 100 Barr Harbor Drive, PO Box C700, West Conshohocken, Pa. 19428-2959, USA.

As used herein, when reference is made to a collection of powder particles, the phrase “most or all of the powder particles” means 50% to 100% of the powder particles, by weight based on the total weight of the collection of powder particles.

As used herein, a “solvent compound” is a compound that has boiling point at one atmosphere pressure of between 20° C. and 200° C. and that is liquid at one atmosphere pressure over a range of temperatures that includes 20° C. to 30° C. A “solvent” can be a solvent compound or a mixture of solvents. A non-aqueous solvent can be a solvent that either contains no water or that contains water in an amount of 10% or less by weight based on the weight of the solvent.

As used herein, the phrase “aqueous medium” refers to a composition that is liquid at 25° C. and that contains 75% or more water by weight, based on the weight of the aqueous medium. Ingredients that are dissolved in the aqueous medium are considered to be part of the aqueous medium, but materials that are not dissolved in the aqueous medium are not considered to be part of the aqueous medium. An ingredient is “dissolved” in a liquid if individual molecules of that ingredient are distributed throughout the liquid and are in intimate contact with the molecules of the liquid.

As used herein, when any ratio is said to be X:1 or higher, that ratio is meant to be Y:1, where Y is X or higher. Similarly, when any ratio is said to be R:1 or lower, that ratio is meant to be S:1, where S is R or lower.

As used herein, the “aspect ratio” of a solid particle is the ratio of the particle's longest dimension to that particle's shortest dimension. A particle's longest dimension is the length of the longest possible line segment (“segment L”) that passes through the particle's center of mass and that has each of its end points on the surface of the particle. That particle's shortest dimension is the length of the shortest possible line segment (“segment S”) that passes through the particle's center of mass, that has each of its end points on the surface of the particle, and that is perpendicular to segment L. The aspect ratio is the ratio of the length of segment L to the length of segment S.

As used herein, when a property of a powder is described as having a “median” value, it is contemplated that half of the total volume of powder particles will consist of particles that have that property with value above that median value and that half of the total volume of powder particles will consist of particles that have property with value below that median value.

The practice of the present invention involves the use of one or more cyclopropene compound. As used herein, a cyclopropene compound is any compound with the formula:

[chemical structure]

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R^{I} is methyl and each of R², R³, and R⁴ is hydrogen, and the cyclopropene compound is known herein as 1-methylcyclopropene or “1-MCP.”

In one embodiment, a cyclopropene compound can be used that has boiling point at one atmosphere pressure of 50° C. or lower; 25° C. or lower; or 15° C. or lower. In another embodiment, a cyclopropene compound can be used that has boiling point at one atmosphere pressure of −100° C. or higher; −50° C. or higher; −25° C. or higher; or 0° C. or higher.

The composition of the present invention includes at least one molecular encapsulating agent. In preferred embodiments, at least one molecular encapsulating agent encapsulates one or more cyclopropene compound or a portion of one or more cyclopropene compound. A complex that contains a cyclopropene compound molecule or a portion of a cyclopropene compound molecule encapsulated in a molecule of a molecular encapsulating agent is known herein as a “cyclopropene compound complex” or “cyclopropene molecular complex.”

In one embodiment, at least one cyclopropene compound complex is present that is an inclusion complex. In a further embodiment for such an inclusion complex, the molecular encapsulating agent forms a cavity, and the cyclopropene compound or a portion of the cyclopropene compound is located within that cavity.

In another embodiment for such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene compound molecule or portion thereof to remain within the cavity of the molecular encapsulating agent.

The amount of molecular encapsulating agent can usefully be characterized by the ratio of moles of molecular encapsulating agent to moles of cyclopropene compound. In one embodiment, the ratio of moles of molecular encapsulating agent to moles of cyclopropene compound can be 0.1 or larger; 0.2 or larger; 0.5 or larger; or 0.9 or larger. In another embodiment, the ratio of moles of molecular encapsulating agent to moles of cyclopropene compound can be 10 or lower; 5 or lower; 2 or lower; or 1.5 or lower.

Suitable molecular encapsulating agents include, for example, organic and inorganic molecular encapsulating agents. Suitable organic molecular encapsulating agents, which include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In one embodiment, the encapsulating agent is alpha-cyclodextrin, beta-cyclodextrin, gamma-cyclodextrin, or combinations thereof. In a further embodiment, alpha-cyclodextrin is used.

Provided is a method of making the powder composition of the present invention. The method includes the step of making a powder (herein called the “complex powder” or “HAIP”) that contains cyclopropene compound complex. In some embodiments, the complex powder contains no fatty compound; or if any fatty compound is present, the amount of all fatty compounds is less than 1% by weight based on the weight of the complex powder. Usually, each particle of the complex powder contains many molecules of molecular encapsulating agent in which a molecule of a cyclopropene compound is encapsulated. The complex powder may also contain one or more adjuvants, including, for example, one or more mono- or di-saccharide compound, one or more metal complexing agent, or combinations thereof.

In one embodiment, complex powders may have median particle diameter of 10 micrometers or less; 7 micrometers or less; or 5 micrometers or less. In another embodiment, complex powders may have median particle diameter of 0.1 micrometer or more; or 0.3 micrometer or more. Median particle diameter may be measured by light diffraction using a commercial instrument such as those manufactured, for example, by Horiba Co. or Malvern Instruments.

In another embodiment, complex powders may have median aspect ratio of 5:1 or lower; 3:1 or lower; or 2:1 or lower. If a complex powder is obtained that has undesirably high median aspect ratio, mechanical means may be used, for example, milling, to reduce the median aspect ratio to a desirable value.

Provided is a method of making the powder composition of the present invention. The method comprises the following steps. First, a complex powder is made, for example as disclosed in U.S. Pat. No. 6,017,849. Then, the complex powder particles are covered with a first covering (or first coating), which contains a fatty compound having a melting point of 50° C. to 110° C., and the result is a collection of powder particles that are herein called “fatty-coated” powder particles. After that, the fatty-coated powder particles are covered with a second covering (or second coating), which contains a water-insoluble polymer having a softening point of greater than 110° C. At the completion of the method of making the powder composition of the present invention, the complex powder has become the inner particles; the first covering (or first coating) has become the inner covering (or inner coating), and the second covering (or second coating) has become the outer covering (or outer coating).

The inner covering (or inner coating) of the present invention involves the use of a fatty compound having melting point of 50° C. to 110° C. If a fatty compound has more than one melting point, the “melting point” of that fatty compound is herein considered to be the lowest melting point that accounts for 10% or more of the total melting exotherm. Melting points and melting exotherms may be observed using differential scanning calorimetry (DSC).

Fatty compounds include, for example, fatty acids, fatty alcohols, mono- and di-esters, fatty hydrocarbons, fatty oils and waxes, natural or synthetic, modified versions thereof, and mixtures thereof. Suitable modifications include any process, including chemical reactions, that alters the composition of a fatty compound, as long as the resulting compound still meets the definition of fatty compound. Modifications include, for example, hydrogenation, esterification, trans-esterification, de-esterification, polymerization, attachment of functional groups, and combinations thereof. Fatty acids have the formula R—COOH, where the R group contains a fatty group. Fatty hydrocarbons are fatty compounds that contain only carbon and hydrogen atoms. Fatty oils, fatty alcohols, mono- and di-esters, and waxes are fatty compounds that contain one or more ester group, hydroxyl group, aldehyde group, ketone group, or combination thereof.

Suitable fatty compounds include at least one fatty group having 16 or more carbon atoms. Examples of fatty compounds include at least one fatty group having 18 or more carbon atoms. Additional examples of fatty compounds include fatty acids, fatty alcohols, mono- and di-esters, triglycerides, polyolefin waxes, microcrystalline wax, carnauba wax, natural or synthetic and combinations thereof. Triglycerides are triesters of glycerol with three fatty acids. In one embodiment among fatty acids, the fatty acids do not have pendant hydroxyl groups. When oils that contain carbon-carbon double bonds are hydrogenated, the extent of the hydrogenation process can determine the melting point of the hydrogenated oil. It is contemplated that when hydrogenated oil is used in the present invention, the extent of hydrogenation will be determined to make the melting point of the hydrogenated oil fall within the melting point ranges discussed below as appropriate for use in the present invention. Suitable triglycerides include hydrogenated soybean oil, hydrogenated sunflower oil, and hydrogenated cottonseed oil. In another embodiment, fatty compounds include triglycerides, polyolefin waxes, or combinations thereof.

Polyolefin waxes are oligomers that have monomer units of ethylene, propylene, or a mixture thereof. Suitable polyolefin waxes have number-average molecular weight of 700 or lower. In one embodiment, polyolefin waxes include polymers that have no polymerized units other than ethylene, propylene, or combinations thereof. In another embodiment, polyolefin waxes include polyethylene homopolymer waxes. Independent of monomer type, polyolefin waxes may have number-average molecular weight of 200 or higher; or 400 or higher.

Fatty compounds useful in the present invention have melting point of 50° C. to 110° C. It is contemplated that if the melting point is too low, the powder composition will be sticky, and the powder will not flow properly. It is also contemplated that if the melting point is too high, when cyclopropene compound complex is mixed with molten fatty compound, the temperature will be high enough to cause significant degradation of the cyclopropene compound and/or the HAIP complex.

In one embodiment, suitable fatty compounds may have melting point of 55° C. or higher; 65° C. or higher; or 70° C. or higher. In another embodiment, suitable fatty compounds may have melting point of 100° C. or lower; or 90° C. or lower.

Another method of assessing fatty compounds is the temperature of onset of the melting point. To determine the onset temperature, the exotherm curve (heat flow vs. temperature) produced by the DSC for the melting point transition is observed. The baseline is determined, and a corrected heat-flow curve calculated by subtracting the baseline from the original heat-flow curve. The maximum heat-flow value of the corrected curve (HFMAX) is determined. The onset temperature is the lowest temperature at which the heat-flow value on the corrected curve is equal to 0.1*HFMAX. Suitable fatty compounds may have onset temperature of 45° C. or higher; or 55° C. or higher under both first and later heat cycles.

In one embodiment, in the powder composition of the present invention, within an individual powder particle, a fatty compound forms a covering (or coating) over inner particles that contain cyclopropene compound complex.

Provided is a method of making the powder composition of the present invention. The method comprises making fatty-coated powder particles. In one embodiment, the method of making fatty-coated powder particles involves mixing complex powder with molten fatty compound. This mixture may then be separated into individual powder particles by any method. Also provided is a method of turning the molten mixture into powder particles comprising spray chilling. Spray chilling is a process that involves forming droplets of the molten mixture and dispersing those droplets in air; as the droplets fall due to gravity, they cool and form solid powder particles. The air may be still or may be given an upward current. The droplets may be formed by passing the molten mixture through a spray head or a nozzle or by flinging molten mixture off of a rotating disk by centrifugal force.

An alternative method of producing fatty-coated powder particles comprises non-aqueous spray drying. In this method, using a non-aqueous solvent, fatty compound is dissolved and complex powder is dispersed, and the resulting mixture is spray dried.

In one embodiment when powder particles are formed by any of the above methods, most or all of the complex powder particles remain intact and become the inner particles within each of the fatty-coated powder particles. In another embodiment in the fatty-coated powder particles, the outer surface of each fatty-coated powder particle is composed mostly or entirely of the fatty compound. That is, it is contemplated that most or all of the fatty-coated powder particles have surface area in which 50% or more of the surface, based on the surface area of that particle, is composed of fatty compound. In a further or alternative embodiment, for most or all of the fatty-coated powder particles, each fatty-coated powder particle contains one or more particles of complex powder.

In one embodiment, the powder compositions provided contain one or more dispersant. Dispersants are compounds that assist in suspending solid particles in a liquid medium. Typical dispersants are polymeric or oligomeric. It is contemplated that a dispersant will aid in distributing the inner particles throughout the liquid form of the fatty compound (i.e., molten or dissolved fatty compound) during the process of forming the powder particles. The suitable amount of dispersant may be, by weight based on the weight of the overcoated powder composition of the present invention, 0.05% or more; 0.1% or more; or 0.2% or more. In another embodiment, the suitable amount of dispersant may be, by weight based on the weight of the overcoated powder composition of the present invention, 5% or less; or 2% or less.

Some powder compositions of the present invention contain one or more “additional polymer” in addition to the fatty compound having melting point of 50° C. to 110° C. Such an additional polymer is chosen independently of the polymer used in the outer coating. Examples of additional polymers may be miscible with the fatty compound having melting point of 50° C. to 110° C., while that fatty compound is in the melt state.

In one embodiment, the fatty compound having melting point of 50° C. to 110° C. contains one or more hydrogenated triglyceride and one or more additional polymer. In a further embodiment, additional polymers include copolymers of olefin monomer with one or more non-olefin monomer. Suitable non-olefin monomers may be vinyl esters of aliphatic carboxylic acids and unsaturated carboxylic acids. Suitable additional polymers may have relatively high molecular weight. Molecular weight can be judged by melt flow rate, using ASTM D1238, at 190° C. with 2.16 kg. Examples of additional polymers may have melt flow rate of 1 g/10 min or higher; or 3 g/10 or higher. In another embodiment, additional polymers may have melt flow rate of 20 g/10 min or lower; or 10 g/10 min or lower.

In one embodiment, the amount of fatty compound in the fatty-coated powder particles, by weight based on the weight of the fatty-coated powder particles, may be 40% or more; or 50% or more. In another embodiment, the amount of fatty compound in the fatty-coated powder particles, by weight based on the weight of the fatty-coated powder particles, may be 99% or less; or 95% or less.

Also provided is a method of making the powder composition of the present invention. The method comprises applying, to fatty-coated particles, a second covering (or second coating), that contains a water-insoluble polymer. The second covering (or second coating) may be applied by methods known in the art. Examples of such methods include dissolving or dispersing the polymer in a solvent, and then mixing the resulting solution or dispersion with fatty-coated powder particles, and removing the solvent in a way that yields a polymer-containing coating on the surfaces of the fatty-coated particles. The particles are then referred to as “polymer-coated particles” or “overcoated particles.” Examples of methods for applying the second covering (or second coating or overcoating) include fluid-bed drying and/or spinning disk drying and/or spraying drying.

In fluid-bed (or Wurster) coating, a fluidised bed of dry particles has a coating solution sprayed onto the fluidised bed and solidified on the particles by either evaporation of a volatile solvent in the coating solution or cooling to set the coating polymer (if applied in molten form). Provided is the coating of a collection of fatty-coated powder particles in a fluid-bed with polymer by spraying a solution of polymer dissolved in solvent or a liquid dispersion of polymer.

Spinning-disk drying may involve a non-aqueous solvent or may involve an aqueous medium. In spinning-disk drying involving a non-aqueous solvent, a non-aqueous solvent is selected in which a convenient amount of the polymer will dissolve but in which the fatty compound in the fatty-coated powder particles does not dissolve to any significant extent. A slurry can be formed by agitating fatty-coated particles in a solution of polymer in solvent. In spinning-disk drying involving an aqueous medium, a dispersion is provided that contains dispersed particles of a polymer; such a dispersion is generally called a latex. If the latex was farmed by the method of emulsion polymerization, the latex may be called a “polymer emulsion.” A slurry is formed by agitating fatty-coated particles in the latex. In all types of spinning-disk drying, the slurry is placed on a spinning disk, which flings droplets of the slurry into the air. In the air, the solvent evaporates from the droplets, yielding polymer-coated particles. In a spray drying process, the polymer was dissolved in a solvent, preferably an none-aqueous solvent, the fatty-coated powder particles were dispersed in the solvent, sprayed dried and solvent evaporates in the process.

Thus, the second coating becomes the outer coating of the powder particles provided.

The polymer used in the outer coating (i.e., the second coating or overcoating) may have any composition as long as the polymer is water-insoluble. In one embodiment, the amount of the polymer dissolved in 100 grams of water at 25° C. may be 0.3 gram or less; or 0.1 gram or less.

In another embodiment for polymers used in the outer coating, its softening point may be 110° C. or higher; 120° C. or higher; or 130° C. or higher. In another embodiment for polymers used in the outer coating, its softening point may be 250° C. or lower.

Examples of polymers include acrylic polymers, alkylated celluloses, and polyterpenes. Acrylic copolymers contain 50% or more by weight of acrylic monomer units. An acrylic monomer is a monomer selected from acrylic acid, methacrylic acid, substituted or unsubstituted esters of acrylic acid or methacrylic acid, substituted or unsubstituted amides of acrylic acid or methacrylic acid, or mixtures thereof. Alkylated cellulose is cellulose in which some or all of the pendant —OH groups have been replaced by —OR groups, where R is an alkyl group. One suitable example includes ethylated cellulose. Polyterpenes are polymers whose repeat unit is isoprene. In one embodiment, suitable polyterpenes may have number-average molecular weight of 725 or above. In another embodiment, suitable polyterpenes may have number-average molecular weight of 2000 or below. In another embodiment, suitable polyterpenes may have softening point of greater than 110° C.

In one embodiment, the amount of the outer covering (or outer coating), by weight based on the weight of the powder composition of the present invention, 10% or more; or 15% or more. In another embodiment, the amount of the outer covering (or outer coating) may be, by weight based on the weight of the final powder composition of the present invention, 50% or less; or 30% or less.

One useful way to characterize the powder composition of the present invention is the median particle diameter, which may be 10 to 500 micrometers. In one embodiment, the median particle diameter may be 250 micrometers or less; 150 micrometers or less; 100 micrometers or less; 75 micrometers or less; or 60 micrometers or less as determined by a light diffraction method.

Another useful way to characterize the powder composition of the present invention is to measure dQ, where Q is a number less than 100. In a particular collection of powder particles, powder particles representing Q % of the total volume of all the powder particles will have particle diameter of less than dQ, while powder particles representing (100−Q) % of the total volume of all the powder particles will have particle diameter of more than dQ.

In some embodiments, the powder composition of the present invention may have d90 of 250 micrometers or less; 200 micrometers or less; 150 micrometers or less; or 100 micrometers or less. In some embodiments, the d90 is between 100 and 250 micrometers; between 150 and 250 micrometers; or between 100 and 200 micrometers. Independently, the powder composition of the present invention preferably has d10 of 1 micrometer or more; more preferably 3 micrometers or more. In some embodiments, the d10 is between 1 and 3 micrometers, between 3 and 10 micrometers, or between 1 and 10 micrometers.

The powder composition of the present invention may be altered to form an intermediate solid composition or an intermediate liquid composition or a combination thereof. An intermediate solid composition is a solid composition made from the powder composition of the present invention, optionally by a method that includes mixing the powder composition of the present invention with additional ingredients; some intermediate solid compositions are particulate compositions with larger or smaller particle size than the powder composition of the present invention. For another example, the powder composition of the present invention may be mixed with a liquid, either an aqueous medium or some other liquid, to form an intermediate liquid composition; such an intermediate liquid composition may or may not be further diluted prior to contact with plants or plant parts.

The powder composition of the present invention may be used for treating plants or plant parts in any way. For example, the powder composition may be mixed with other materials or may be used directly.

Provided is a method of using the composition of the present invention for a formation of an aqueous slurry. An aqueous slurry can be formed when the composition provided is mixed with an aqueous medium. To form such a slurry, the aqueous medium may be mixed directly with the composition of the present invention or with one of the intermediate compositions described herein above. It is expected that the overcoated particles of the composition provided remain intact in the slurry. It is also contemplated that most or all of the overcoated particles will be dispersed in the slurry as individual particles rather than as agglomerates thereof. The overcoated particles may require mechanical agitation to remain suspended in the aqueous medium, or they may remain suspended without agitation.

The amount of composition provided in the slurry may be characterized by the concentration of cyclopropene compound in the slurry. In one embodiment, suitable slurries may have cyclopropene compound concentration, in units of milligrams of cyclopropene compound per liter of slurry, of 2 or higher; 5 or higher; or 10 or higher. In another embodiment, suitable slurries may have cyclopropene compound concentration, in units of milligrams of cyclopropene compound per liter of slurry, of 1000 or lower; 500 or lower; or 200 or lower.

The amount of water in the aqueous medium used in the slurry may be, by weight based on the weight of aqueous medium, 80% or more; 90% or more; or 95% or more.

The slurry may optionally contain one or more adjuvants, for example, one or more metal complexing agent, one or more surfactant, one or more oil, one or more alcohol, or mixtures thereof. Examples of metal-complexing agents, if used, include chelating agents. Examples of surfactants, if used, include anionic surfactants, non-ionic surfactants, and silicone surfactants. Examples of alcohols, if used, include alkyl alcohols with 4 or fewer carbon atoms. Oils are compounds that are liquid at 25° C., are not water, are not surfactants, and are not alcohols. Examples of oils, if used, include hydrocarbon oils and silicone oils.

Also provided is a method of treating plants by bringing the slurry into contact with plants or plant parts. Such contacting may be performed in any location, including inside enclosed spaces (for example, containers, rooms, or buildings) or outside of an enclosed space. In one embodiment, such contacting is performed outside of any enclosed space. As used herein, “outside of any enclosed space” means outside of any building or enclosure or else in a room or building that is ventilated to outdoor atmosphere. In another embodiment, such contacting is performed outside of any building or enclosure. In a further embodiment, such contacting is performed in an outdoor field or plot.

The slurry of the present invention may be brought into contact with plants or plant parts by methods known in the art. Examples of methods include dipping plant parts into the slurry and applying slurry to plants or plant parts by spraying, foaming, brushing, or combinations thereof. Other examples include spraying the slurry onto plants or plant parts and dipping plant parts into the slurry. Additional examples include spraying the slurry onto plants or plant parts.

Plants or plant parts may be treated in the practice of the present invention. One example is treatment of whole plants; another example is treatment of whole plants while they are planted in soil, prior to the harvesting of useful plant parts.

Any plants that provide useful plant parts may be treated in the practice of the present invention. Examples include plants that provide fruits, vegetables, and grains.

As used herein, the phrase “plant” includes dicotyledons plants and monocotyledons plants. Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale. Examples of fruit include papaya, banana, pineapple, oranges, grapes, grapefruit, watermelon, melon, apples, peaches, pears, kiwifruit, mango, nectarines, guava, persimmon, avocado, lemon, fig, and berries.

In one aspect, provided is a powder composition comprising a collection of particles (I) having median particle diameter of 10 micrometers to 200 micrometers, wherein each of said particles (I) comprises: (a) a covering of a fatty compound having melting point of 50° C. to 110° C. and (b) one or more inner particles (II) comprising one or more complex that contains a cyclopropene compound molecule or a portion of a cyclopropene compound molecule encapsulated in a molecule of a molecular encapsulating agent.

In one embodiment, said collection of particles (I) has median particle diameter of 10 micrometers to 100 micrometers. In another embodiment, said fatty compound has melting point of 70° C. to 90° C. In another embodiment, said fatty compound comprises at least one of hydrogenated sun flower oil, hydrogenated soybean oil, hydrogenated cottonseed oil, or microcrystalline wax, and polyethylene homopolymer wax, carnauba wax, synthetic or natural. In another embodiment, the amount of said fatty compound is 50% to 99% by weight based on the weight of said powder composition.

In one embodiment, said collection of particles (I) has median particle diameter of 10 micrometers to 100 micrometers; said fatty compound has melting point of 70° C. to 90° C.; and the amount of said fatty compound is 50% to 99% by weight based on the weight of said powder composition. In another embodiment, said powder composition additionally comprises one or more dispersant. In another embodiment, said powder composition additionally comprises one or more polymer.

In another aspect, provided is a slurry comprising an aqueous medium and a collection of particles (I) having median particle diameter of 10 micrometers to 200 micrometers, wherein each of said particles (I) comprises (a) a covering of a fatty compound having melting point of 50° C. to 110° C. and one or more inner particles (II) comprising one or more complex that contains a cyclopropene compound molecule or a portion of a cyclopropene compound molecule encapsulated in a molecule of a molecular encapsulating agent.

In another aspect, provided is a method of treating plants or plant parts comprising contacting said plants or plant parts with a slurry comprising an aqueous medium and a collection of particles (I) having median particle diameter of 10 micrometers to 200 micrometers, wherein each of said particles (I) comprises (a) a covering of a fatty compound having melting point of 50° C. to 110° C. and (b) one or more inner particles (II) comprising one or more complex that contains a cyclopropene compound molecule or a portion of a cyclopropene compound molecule encapsulated in a molecule of a molecular encapsulating agent.

### EXAMPLES

In the following Examples, the following abbreviations are used:
FC50=any fatty compound having melting point of 50° C. to 110° C.
AP1=HAIP=powder containing 1-MCP encapsulated in alpha-cyclodextrin, with concentration of 1-MCP of 4.5% by weight, and approximately 5% water, by weight. Milled until dv50 was 2 to 5 micrometers.
WX1=DRITEX™ S, hydrogenated soybean oil, from ACH Food & Nutrition Co.
WX2=POLYWAX™ 500 polyethylene wax, from Baker Hughes Inc.
WX3=MC=Microcrystalline wax, for example from the International Group Inc.
DP1=ATLOX™ 4914 dispersant, a nonionic polymer, from Croda Co.
DP2=AGRIMER™ AL-22, dispersant, alkylated vinylpyrrolidone copolymers, for example from International Specialty Products Corp or Ashland Inc.
PY1=ELVAX™ 4355 terpolymer of ethylene/vinyl acetate/acid from DuPont Co.
SS1=SILWET™ L-77 surfactant, based on a trisiloxane ethoxylate, from Momentive Performance Materials, Inc.
SS2=AEROSOL™ OT-B surfactant powder, from Cytek Industries, Inc.
SLS=sodium lauryl Sulfate
SOL1=solution in distilled water of 0.05% by weight based on the weight of SOL1, of each of SS1 and SLS.

Procedure P1—Production of Coated Powder: Powder AP 1 was mixed into the molten FC50 under the minimum needed temperature at the desired weight ratio. Other additives, such as dispersants and plasticizer may be added at this time, if desired. The mixture was agitated with a Cowles disc disperser to achieve dispersion of the solids in the mixture. This mixture was then atomized with pressured air. The particles solidified quickly and were collected in a cyclone. The particle size can be controlled by a combination of air pressure, molten wax temperature, flow rates, and composition, and the additives as known in the art.

Procedure P2 (or stress test 2.0)—Evaluation of the release of 1-MCP: A composition containing water and wetting agents and 1-MCP was placed into a 250 ml bottle. The bottle quickly was sealed either with a PTFE/silicone crimp seal via a crimper or with a MININERT™ valve (Supelco Company) on a screw. Both setups allow the sampling of the inside headspace by a syringe and also allow the re-seal of the valve after repeated sampling.

The bottles were placed on top of a shaker and the shaker swirled at a rate of approximately 120 revolutions per minute. The headspace inside the bottle was sampled at pre-determined time intervals and analyzed on an analytical gas chromatograph with the proper column. The amount of 1-MCP that was released into the headspace was calculated based on its concentration and the volume of the headspace. The percentage of 1-MCP released was calculated from the total 1-MCP present in the sample.

### Example 1

Comparative Formulation CFI 1 was a comparative formulation, made using powder AP1 and other ingredients but no FC50. The concentration of 1-MCP in Comparative Formulation CF11 was 1% by weight, based on the weight of CF11. 0.06 gram of CF11 and 10 ml of SOL1 (to give a solution in which the concentration of 1-MCP was 50 mg per liter of solution.) were added to a 250 ml bottle. Procedure P2 is used to measure release of 1-MCP.

TABLE 1

| | |
|---|---|
| CF11 | F12 |

| time (min) | %1-MPC released | time (min) | %1-MCP released |
|---|---|---|---|
| 3.5 | 41 | 3 | 17 |
| 6.5 | 51 | 6 | 26 |
| 10 | 60 | 10 | 33 |
| 15 | 70 | 15 | 40 |
| 20 | 76 | 25 | 46 |
| 25 | 78 | 40 | 53 |
| 30 | 86 | 60 | 57 |
| 40 | 93 | 90 | 63 |
| 50 | 96 | 120 | 69 |
| 60 | 100 | 166 | 73 |
| 75 | 100 | 210 | 75 |
| | | 240 | 82 |

Formulation F12 was made as follows. Coated Powder was made using AP1 (10% by weight) and stearic acid (90% by weight) in Procedure P1. 0.2 gram of the coated powder was added to a 250 ml bottle containing 10 ml of SOL1. The amount of AP1 was chosen to yield a solution having approximately 50 mg of 1-MCP per liter of solution. The release of 1-MCP was measured using procedure P2. Results are shown in Table 1. Formulation F12 had slower release of 1-MCP than Comparative Formulation CF 11.

### Example 2

### Effect of Particle Size

Formulation F21 was made as follows. Coated Powder was made using AP1 (10% by weight) and WX1 (90% by weight) in Procedure P1, using conditions adjusted to yield coated powder with median particle diameter of 30 micrometers. The coated powder (0.14 gram) was added to a 250 ml bottle containing 10 ml of SOL1. The amount of AP1 was chosen to yield a formulation having approximately 50 mg of 1-MCP per liter of formulation.

Formulation F22 was made identically to F21, except that the conditions in Procedure P1 were chosen to yield coated powder with median particle diameter of 60 micrometers.

The formulations were tested by Procedure P2 and results are shown in Table 2. Formulation F22 had slower release of 1-MCP than Formulation F21.

TABLE 2

| | |
|---|---|
| F21 (30 micrometers) | F22 (60 micrometers |

| time (min) | %1-MPC released | time (min) | %1-MCP released |
|---|---|---|---|
| 10 | 20 | 10 | 9 |
| 30 | 32 | 30 | 16 |
| 60 | 44 | 60 | 22 |
| 120 | 53 | 120 | 30 |
| 195 | 59 | 195 | 38 |
| 1200 | 77 | 1200 | 67 |

### Example 3

### Headspace in a Commercial Spray Tank

Tests were conducted using the tank of a HARDI™ ES-50 commercial sprayer. The capacity of the tank was 191 liter (50 gallon).

Comparative Formulation CF31 was identical to CF11. CF31 was added to 191 liters of tap water in the tank. Concentration of 1-MCP in the tank was 25 mg/liter.

Formulation F32 was made as follows. Coated Powder was made using AP1 (10% by weight), WX1 (89.5% by weight), and DP1 (0.5% DP1), using Procedure P1. The powder blend was made as follows: Coated powder was blended with 1.9% (by weight based on the weight of powder blend) SLS (powder) and 4.8% SS2 (by weight based on the weight of powder blend). 191 liter of tap water containing 0.025% SS1, by volume based on the volume of the tap water, was added to the tank. Then some of the water was removed and used to form a slurry with Formulation F32, and the slurry was then added to the remaining water in the tank, with agitation. Concentration of 1-MCP in the tank was 25 mg/liter.

TABLE 3
Headspace concentration of 1-MCP (ppm)

| time(hr) | CF31 | F32 |
|---|---|---|
| 0.5 | 1983 | 867 |
| 1 | 3254 | 1343 |
| 2 | 6692 | 2297 |
| 4 | 13331 | 3714 |
| 6 | | 4937 |
| 9 | | 6767 |

In each case, after the formulation (either CF31 or F32) was added to the tank, the tank was sealed, and 1 ml gas samples were drawn from the headspace port in the tank lid with gas-tight syringes, and the gas samples were analyzed using gas chromatography, reported in “ppm,” which is parts by volume of 1-MCP per million parts by volume of air. Results are shown in Table 3. Formulation F32 releases 1-MCP much more slowly than the comparative formulation CF31.

### Example 4

### Wax Variations

Coated Powders were made using Procedure P1. 0.6 gram of each coated powder was added to 10 ml of SOL1 and placed in a 250 ml bottle and analyzed using procedure P2. The coated powders are shown in Table 4 (by weight percent).

TABLE 4

| Coated Powder | AP1 | WX1 | WX2 | DP2 | PY1 |
|---|---|---|---|---|---|
| F41 | 20 | 79.5 | 0 | 0.5 | 0 |
| F42 | 20 | 77.5 | 0 | 0.5 | 2 |
| F43 | 20 | 0 | 79.5 | 0.5 | 0 |

Results are shown in Table 5. All three have slower release of 1-MCP than the control formulation F11 shown in Table 1.

TABLE 5

| | | |
|---|---|---|
| F41 | F42 | F43 |

| time | %1-MCP | time | %1-MCP | time | %1-MCP |
|---|---|---|---|---|---|
| (min) | released | (min) | released | (min) | released |
| 10 | 6.8 | 10 | 4.7 | 11 | 7.8 |
| 30 | 13.4 | 31 | 9.1 | 31 | 10.4 |
| 60 | 16.7 | 60 | 11.9 | 61 | 12.4 |
| 120 | 20.0 | 120 | 14.8 | 121 | 16.2 |
| 180 | 22.7 | 251 | 18.7 | 192 | 18.8 |
| 300 | 26.1 | 360 | 21.4 | 301 | 21.7 |
| 390 | 28.2 | 1380 | 31.9 | 391 | 24.0 |
| 1380 | 37.2 | | | 1381 | 33.8 |

### Example 5

### Further Wax Comparisons

Coated Powders were made using Procedure P1. 0.1 gram of each coated powder was added to 10 ml of SOL1 and placed in a 250 ml bottle and analyzed using procedure P2. The coated powders are shown in Table 6 (by weight percent).

TABLE 6

| Coated Powder | AP1 | WX1 | WX2 | DP2 |
|---|---|---|---|---|
| F51 | 10 | 89.5 | 0 | 0.5 |
| F52 | 10 | 0 | 89.5 | 0.5 |
| F53 | 30 | 69.25 | | 0.75 |
| F54 | 30 | | 69.25 | 0.75 |

Results are shown in Table 7. All three have slower release of 1-MCP than the control formulation F11 shown in Table 1.

TABLE 7

| F51 | | F52 | | F53 | | F54 | |
|---|---|---|---|---|---|---|---|
| time | % 1-MCP | time | % 1-MCP | time | % 1-MCP | time | % 1-MCP |
| (min) | released | (min) | released | (min) | released | (min) | released |
| 10 | 7 | 10 | 6 | 10 | 12 | 10 | 12 |
| 30 | 13 | 30 | 9 | 30 | 19 | 30 | 16 |
| 60 | 16 | 60.5 | 12 | 60 | 23 | 60.5 | 19 |
| 120 | 21 | 122 | 16 | 120 | 28 | 121 | 23 |
| 180 | 23 | 180 | 20 | 180 | 33 | 181 | 26 |
| 360 | 31 | 360 | 26 | 300 | 38 | 301 | 29 |
| 1380 | 44 | 1380 | 35 | 420 | 43 | 421 | 32 |
| | | | | 1441 | 60 | 1441 | 42 |

### Example 6

### Tomato Epinasty Testing

Tomato epinasty tests were performed as follows: Tomatoes (Rutgers 39 Variety Harris Seeds No 885 Lot 37729-A3) were grown in 2½″ square pots filled with a commercial potting mix. Two seeds were place in each pot. Plants that had expanded first true leaves and were between 5 and 7 inches high were used for the tomato epinasty test. To conduct the assay, a group of pots was placed on a table in a spray booth, and a moving nozzle sprayed a liquid spray composition onto the plants, which were then allowed to dry in a greenhouse.

After a waiting period of 3 days, treated and untreated plants were placed into a plastic box and sealed. To the box, ethylene was injected through a septum, which gave a concentration of 14 ppm. The plants were held sealed for 12-14 hours in the dark with ethylene in the atmosphere. At the end of ethylene treatment, the box was opened and scored for epinasty. The petiole angle of the third leaf is reported. For each type of treatment, five replicate plants were tested, and the average is reported.

Comparative Formulation CF61 contained 1-MCP encapsulated in alpha-cyclodextrin and contained oil but no FC50. CF61 was mixed with water prior to spraying. Coated Powders were made by Procedure P1 as follows: Coated Powder F62 was the same as F32, including blending with SLS and SS1, as described herein above in Example 3. Coated Powder F63 was prepared the same way as F62, including blending with SLS and SS1, except that the coated powder in F63 contained 69.25% WX1, 30% AP1, and 0.75% DP2, by weight based on the weight of the coated powder. Each of F62 and F63 was placed in a solution; that solution was 0.038% SS1 in water, by volume based on the volume of the solution. CF61 was placed in water. The spray treatments were all conducted under the same mechanical spray conditions. For each treatment, the concentration of formulation or powder in the solution was adjusted to give the spray rate (in grams of 1-MCP per hectare) that is shown below. Results of the test plants are shown in Table 8. Results (average petiole angle) of the control plants were as follows:

Untreated (no exposure to ethylene and no spray treatment): 60 degrees

Unsprayed (exposure to ethylene but no spray treatment): 127 degrees

TABLE 8

| | SR = 10⁽¹⁾ | SR = 20⁽¹⁾ | SR = 40⁽¹⁾ |
|---|---|---|---|
| Sample | Angle⁽²⁾ | Angle⁽²⁾ | Angle⁽²⁾ |
| CF61 | 127 | 115 | 113 |
| F62 | 99 | 92 | 83 |
| F63 | 114 | 106 | 70 |

Note ⁽¹⁾Spray Rate, in grams of 1-MCP per hectare
Note ⁽²⁾degrees

The examples of the present invention show reduced petiole angle, demonstrating that the treatment with those example formulations blocks the effect of ethylene, allowing the treated plants to behave more like the plants that were not exposed to ethylene.

### Example 7

The 1-methylcyclopropene-Cyclodextrin complex (hereafter “HAIP”) particles are prepared as previously described and coated powder are made using Procedure P1 with a wax or mixture of waxy material, including hydrogenated Stearic acid or vegetable oil, polyethylene wax, microcrystalline wax, and beewax. 0.1-5% surfactants dispersants, and/or plasticizers, including Agrimer Al-22, are added into the preparation.

A second coating (outer coating) is prepared using a polymer including Ethocel or polyterpene.

Three different samples are prepared and release rate of 1-methylcyclopropene (1-MCP) in a water solution is shown in FIG. 1.

F71—a microcrystalline wax particle containing 30% HAIP particles.

F72—a microcrystalline wax particle containing 15% HAIP particles.

F73-F71 further coated with Ethocel to yield particles containing 15% HAIP.

Using Procedure P2 as shown in FIG. 1, both samples F71 and F72 (wax-coated particles) can protect (i.e., delay of 1-MCP release) the HAIP particles well in comparison to unprotected HAIP particles. Typically unprotected HAIP will release 100% 1-MCP in about 30 minutes under such condition (CF11). As expected due to a lower HAIP concentration, F72 with 15% HAIP releases 1-MCP much slower than F71 with 30% HAIP. Unexpectedly, F73, overcoated with the Ethocel, releases 1-MCP about two folds slower than F72 and as the slowest among all three samples, even after six hours with agitation. This much slower release rate will enhance safety by reducing flammable gaseous 1-MCP concentration inside a sprayer and deliver more active to targets. The appearances of the overcoated particles are shown in FIG. 7.

### Example 8

An additional sample, F81 (wax overcoated, Ethocel-coated HAIP), is prepared by first coating the HAIP particles with Ethocel to yield a 70% HAIP in Ethocel, and then overcoated with MC wax, yielding 21% HAIP net. Sample F81 shows faster release of 1-MCP than sample F71 (wax-coated HAIP at 30% HAIP loading) and much faster than F73 (Ethocel overcoated, wax-coated HAIP). Table 9 shows the results including F81.

TABLE 9
1-MCP release rate (%) at 1, 2, and
6 hours under Procedure P2 as FIG. 1.

| # | 1 hour | 2 hours | 6 hours | Composition |
|---|---|---|---|---|
| F71 | 26 | 33 | 43 | 30% HAIP MC wax bead |
| F72 | 16 | 20 | 28 | 15% HAIP in MC wax bead |
| F73 | 6 | 10 | 21 | Net 15% HAIP in MC wax, then |
| | | | | overcoated with Ethocel. |
| F81 | 46 | 54 | 62 | Net 21% HAIP, first 70% wt in |
| | | | | Ethocel, then in MC wax |

Coated powders by Procedure P1 are made with 40% HAIP loading and waxy material Dritex S (DSP). They are further overcoated via a spinning disk process. According to Procedure P2, the release rates of 1-MCP are measured and results of formulations F82, F83 and F84 are shown in Table 10.

TABLE 10

| | Size | HAIP | Compo- | 1 | 2 | 3 | 4 | 6 |
|---|---|---|---|---|---|---|---|---|
| # | (D50u) | % | sition | hour | hours | hours | hours | hours |
| F82 | 98 | 32 | 40% HAIP | 46.8 | 59.9 | 66.0 | 70.4 | 75.6 |
| | | | in DSP + | | | | | |
| | | | 0.5% | | | | | |
| | | | Agrimer | | | | | |
| | | | AL-22/ | | | | | |
| | | | 20% | | | | | |
| | | | overcoat | | | | | |
| | | | of Piccolyte | | | | | |
| | | | A135 + | | | | | |
| | | | 0.01% | | | | | |
| | | | Span 80 | | | | | |
| F83 | 98 | 32 | 40% HAIP | 45.5 | 58.0 | 65.8 | 69.3 | 73.1 |
| | | | in DSP + | | | | | |
| | | | 0.5% | | | | | |
| | | | Agrimer | | | | | |
| | | | AL-22/ | | | | | |
| | | | 20% | | | | | |
| | | | overcoat | | | | | |
| | | | of Piccolyte | | | | | |
| | | | A135 + | | | | | |
| | | | 0.01% | | | | | |
| | | | Span 80 | | | | | |
| F84 | 98 | 32 | 40% HAIP | 53.2 | 66.4 | 74.3 | 79.6 | 83.5 |
| | | | in DSP + | | | | | |
| | | | 0.5% | | | | | |
| | | | Agrimer | | | | | |
| | | | AL-22/ | | | | | |
| | | | 20% | | | | | |
| | | | overcoat | | | | | |
| | | | of Piccolyte | | | | | |
| | | | A135 + | | | | | |
| | | | 0.01% | | | | | |
| | | | Span 80 | | | | | |
| Control | | 40 | 40% HAIP | 50 | 62 | 68 | 73 | 78 |
| CF81 | | | in DSP | | | | | |
| | | | used | | | | | |
| | | | for above | | | | | |
| | | | overcoating | | | | | |

The above data show not all overcoating process or composition is effective in protecting the inner particles. Almost no protective benefits was observed when polyterpene Piccolyte A135 was used to overcoat the coated powder particles made of Dritex S in a spinning disk process. However, polyterpene was found to be very effective in overcoating coated powders made of MC wax or polywax. Accordingly, coated powders containing 20% HAIP, and Polywax and Dritex S separately are coated with polyterpene. The protective results are compared under Procedure P2. Overcoating coated powders made of polywax 500 by polyterpene polymer is effective but to Dritex S is not.

Under procedure P2, the release rate of 1-MCP from polyterpene overcoated powder particles made of polywax is reduced to 3.8%, 5.0%, and 8.8% after 1, 2, and 6 hours agitation while the coated powders made of Dritex S still have 14.8%, 22.2%, and 32.8% after 1, 2 and 6 hours agitation. The results are summarized in Table 11.

TABLE 11

| | | HAIP | | 1 | 2 | 6 | |
|---|---|---|---|---|---|---|---|
| # | Size | % | Composition | hour | hours | hours | Note |
| F85 | 70 | 10 | 50% Piccolyte | 3.8 | 5.0 | 8.8 | From |
| | | | S115 coated | | | | Hexane, |
| | | | powder 60u | | | | 1% Dawn |
| | | | Polywax 500 | | | | solution |
| F86 | 84 | 10 | 50% Piccolyte | 14.8 | 22.2 | 32.8 | From |
| | | | S115 coated | | | | Hexane, |
| | | | powder 60u | | | | 1% Dawn |
| | | | Dritex S | | | | solution |

### Example 9

Overcoating via spray drying: Coated powder particles made of 30% HAIP and Microcrystalline wax are dispersed in hexane, which has dissolved polyterpene Piccolyte A135. The ratio of the polymer to Coated Powders in this slurry is varied from 1:3, 1:2, to 1:1. The slurry is spray dried under the appropriate conditions in less than 2 hours, often less than 1 hour time period. The particles are collected and release rates of the active are analyzed in the presence of wetting agents versus un-overcoated control. A set of samples #1-8 are prepared and the protective results according to Procedure P2 are shown in FIGS. 2-4, where faster release rates indicate a poorer protection.

A comparison of overcoated particles and un-overcoated particles (i.e., coated particles or prills) made from microcrystalline wax (MO8476-9 (#1 & 2/3) is shown in FIG. 2, where representative release rates under Procedure P2 of the first group (initial coating—brushdown samples) are shown with 25% polymer. Initial sample shows dramatic reduction in release rate (i.e., increased protection).

Also a comparison of spray overcoated samples (#5-8) with 25%, 33% and 50% overcoating polymer is shown in FIG. 3, where representative results of stress testing 2.0 (ST2.0) of the second group are shown. Significant protection was achieved through a spray drying overcoating process.

Exemplary relationship for coating impact between release % of the active and polymer Piccolyte A135 wt % is shown in FIG. 4, where representative release rates under stress testing 2.0 (ST2.0) versus coating wt % are shown. The data suggest that the more the coating polymer, the better the protection for the active ingredient 1-MCP.

Samples in this example are prepared using spray drying from coated powder particles dispersed in a hexane containing polyterpene Piccolyte A135. The results show the method provided in this example is a major improvement in protecting release of active ingredient in water compared to existing formulations.

### Example 10

Benefit of overcoating via fluid bed process—Coated Powders with 30% and 40% HAIP in Dritex S wax are overcoated by Neocryl XK-82, which is a 40% wt emulsion of polyacrylic-styrene polymer in water. The prills are fluidized in a Hurtling Univac fluid-bed coater with a bed temperature of 35° C. and the solution is injected under the proper temperatures and injection rates. After the target solid is injected, the coating is stopped and sample is analyzed for protection under Procedure P2, and compared with the unovercoated control (i.e., coated particles or prills).

Exemplary results of overcoating coated powders containing 30% w/w HAIP and Dritex S wax with 20% wt Neocryl XK82 are shown in FIG. 5. Clear protection with 20% polymer coating can be observed.

Exemplary results of overcoating coated powders with 40% w/w HAIP and Dritex S with various amounts of Neocryl XK-82 are shown in FIG. 6. Clear protection with 20% and 28% polymer coating can be observed.

Samples in this example are prepared from fluid bed coating with an aqueous emulsion of Neocryl XK-82. The results show the method provided in this example is also a major improvement in protecting release of active ingredient in water compared to existing formulations.

Overcoating with fluid bed coating process: Overcoating polymer Neocryl Xk-82 can overcoat Dritex S prills 1-2 times with 28% overcoating, but not at 14% overcoating. However, Xk-82 does not overcoat polywax prills at all. Another overcoating polymer, SBD (styrene butadiene) is not effective for overcoating wax-coated particles. Results in Table 12 and FIG. 7 show no effect of XK-82 of SBD coating on polywax.

TABLE 12
% of 1-MCP released

| | time | | | |
|---|---|---|---|---|
| | 30 | 60 | 120 | 240 |
| Sample description | minutes | minutes | minutes | minutes |
| 30% w/w HAIP Dritex S prill | 21.66 | 28.08 | 35.95 | 44.42 |
| 20% w/w XK-82 on 30% w/w | 7.81 | 11.92 | 15.73 | 20.49 |
| HAIP Dritex S prill | | | | |
| 40% w/w HAIP Dritex S prill | 43.58 | 51.25 | 60.11 | 67.45 |
| 20% w/w XK-82 on 40% w/w | 15.22 | 20.10 | 26.58 | 33.43 |
| HAIP Dritex S prill | | | | |
| 30% w/w Microcrystalline | 13.51 | 16.58 | 21.26 | 28.91 |
| wax prill | | | | |
| 20% polyterpene on 30% w/w | 10.46 | 14.37 | 19.92 | 28.78 |
| Microcrystalline wax prill | | | | |
| 10% polyterpene | 10.69 | 14.67 | 21.21 | 30.64 |
| coating on 30% w/w | | | | |
| Microcrystalline wax prill | | | | |
| 5% polyterpene | 7.47 | 11.26 | 17.78 | 27.78 |
| coating on 30% w/w | | | | |
| Microcrystalline wax prill | | | | |

What is claimed is:

1. A composition comprising a collection of powder particles, wherein each of the powder particles comprises,
(a) one or more inner particles comprising a complex powder, the complex powder comprises a cyclopropene compound encapsulated by a molecular encapsulating agent;
(b) a first coating comprising a water-insoluble material; and
(c) a second coating comprising a water-insoluble polymer or a water-resistant film.

2. A composition comprising a collection of powder particles, wherein each of the powder particles comprises,
(a) one or more inner particles comprising a complex powder, the complex powder comprises a cyclopropene compound encapsulated by a molecular encapsulating agent; each of the one or more inner particles comprises a first coating comprising a water-insoluble material; and
(b) a second coating comprising a water-insoluble polymer or a water-resistant film.

3. The composition of claim 1, wherein the water-insoluble material of the first coating comprises a fatty compound or a waxy material.

4. The composition of claim 1, wherein the water-insoluble polymer of the second coating is different than the water-insoluble material of the first coating.

5. The composition of claim 1, wherein the powder particles have median particle diameter of 10 micrometers to 500 micrometers.

6. The composition of claim 1, wherein the powder particles have median particle diameter of 20 micrometers to 250 micrometers.

7. The composition of claim 3, wherein the fatty compound or waxy material of the first coating has a melting point of 50° C. to 110° C.

8. The composition of claim 3, wherein the fatty compound or waxy material of the first coating has a melting point of 70° C. to 90° C.

9. The composition of claim 3, wherein the fatty compound or waxy material of the first coating comprises at least one of hydrogenated soybean oil, hydrogenated cottonseed oil, hydrogenated sunflower oil, microcrystalline wax, polyethylene homopolymer wax, and natural or synthetic waxes including Beeswax and Carnauba wax.

10. The composition of claim 1, wherein the water-insoluble polymer or water-resistant film of the second coating comprises acrylic polymers, alkylated celluloses, polyterpenes, or combinations thereof.

11. The composition of claim 1, wherein the water-insoluble polymer or water-resistant film of the second coating comprises ethylcellulose polymers.

12. The composition of claim 11, wherein the ethylcellulose polymers comprise Ethocel.

13. The composition of claim 1, wherein the composition is prepared using spray drying from prills dispersed in a hydrophobic solvent.

14. The composition of claim 13, wherein the hydrophobic solvent is hexane.

15. The composition of claim 1, wherein the composition is prepared using spray drying from prills dispersed in a hydrophilic solvent.

16. The composition of claim 15, wherein the hydrophilic solvent is acetone.

17. The composition of claim 1, wherein the composition comprises polyterpene resin Piccolyte A135, S115, or S125.

18. The composition of claim 17, wherein the polyterpene resin Piccolyte A135, S115, or S125 is by weight from 10% to 50%.

19. The composition of claim 1, wherein the composition is prepared from fluid bed coating.

20. The composition of claim 19, wherein the fluid bed coating comprises an aqueous dispersion of an acrylic copolymer.

21. The composition of claim 20, wherein the acrylic copolymer is by weight from 20% to 30% of the final composition

22. A slurry comprising an aqueous medium and a collection of particles, wherein each of the powder particles comprises,
(a) one or more inner particles comprising a complex powder, the complex powder comprises a cyclopropene compound encapsulated by a molecular encapsulating agent;
(b) a first coating comprising a water-insoluble material; and
(c) a second coating comprising a water-insoluble polymer or a water-resistant film.

23. A slurry comprising an aqueous medium and a collection of particles, wherein each of the powder particles comprises,
(a) one or more inner particles comprising a complex powder, the complex powder comprises a cyclopropene compound encapsulated by a molecular encapsulating agent; each of the one or more inner particles comprises a first coating comprising a water-insoluble material; and
(b) a second coating comprising a water-insoluble polymer or a water-resistant film.

24. A method of treating plants or plant parts comprising contacting said plants or plant parts with a slurry comprising an aqueous medium and a collection of particles, wherein each of the powder particles comprises,
(a) one or more inner particles comprising a complex powder, the complex powder comprises a cyclopropene compound encapsulated by a molecular encapsulating agent;
(b) a first coating comprising a water-insoluble material; and
(c) a second coating comprising a water-insoluble polymer or a water-resistant film.

25. A method of treating plants or plant parts comprising contacting said plants or plant parts with a slurry comprising an aqueous medium and a collection of particles, wherein each of the powder particles comprises,
(a) one or more inner particles comprising a complex powder, the complex powder comprises a cyclopropene compound encapsulated by a molecular encapsulating agent; each of the one or more inner particles comprises a first coating comprising a water-insoluble material; and
(b) a second coating comprising a water-insoluble polymer or a water-resistant film.
